(19) United States
(12) Patent Application Publication
(10) Pub. No.: US 2026/0210541 A1
(43) Pub. Date: Jul. 23, 2026

(54) Storage Container

(71) Applicant: Harutyun Vardanyan, Louisville, KY (US)

(72) Inventor: Harutyun Vardanyan, Louisville, KY (US)

(21) Appl. No.: 19/453,662

(22) Filed: Jan. 20, 2026

Related U.S. Application Data
(60) Provisional application No. 63/747,787, filed on Jan. 21, 2025.

(51) Int. Cl. F21V 33/00; A45C 11/24; A45C 13/30; A45C 15/06

(52) U.S. Cl. CPC F21V 33/0004; A45C 11/24; A45C 13/30; A45C 15/06

(57) ABSTRACT

A storage container with a light source integrated into the wall of the container that illuminate the exterior wall of the cylinder is described. The storage container may optionally include reversibly attached end caps, attachment points for straps or carabiners, a plurality of lights that illuminate the interior wall of the cylinder, a battery pack or power bank, at least one wireless speaker, or a digital tracking tag. The light source may be voice activated.

### CROSS-REFERENCE TO PRIOR APPLICATIONS

The present application claims priority to U.S. Patent Application 63/747,787, filed 21 Jan. 2025, currently pending, which is incorporated herein in its entirety by reference.

### FEDERALLY SPONSORED RESEARCH AND DEVELOPMENT

Not applicable.

### JOINT RESEARCH AGREEMENT

Not applicable.

### REFERENCE TO A “SEQUENCE LISTING”, A TABLE, OR A COMPUTER PROGRAM LISTING APPENDIX SUBMITTED ON A COMPACT DISC AND AN INCORPORATION BY REFERENCE OF THE MATERIAL ON THE COMPACT DISC.

Not applicable.

### STATEMENT REGARDING PRIOR DISCLOSURES BY AN INVENTOR OR JOINT INVENTOR

Not applicable.

### BACKGROUND OF THE INVENTION

### (1) Field of the Invention

The presently-disclosed subject matter relates to personal storage containers.

### (2) Description of Related Art Including Information Disclosed Under 37 CFR 1.97 and 37 CFR 1.98

Individuals who go hiking or camping often remove small, loose items—such as car fobs, loose change, credit card holders, cell phones—from their pockets. Placing these items on an exposed surface risks loss, either by accidentally failing to collect all items after the activity or by having the item(s) taken by another person. Further, while hiking or camping the individual may be exposed to low light conditions, such as before dawn, or after dusk, or when in a densely treed area.

Thus, it would be beneficial to have a container that would allow the user to store the loose items securely and that could also be used as a light source.

### Summary of the Present Invention

The present development is a storage container with a light source integrated into the wall of the container that illuminate the exterior wall of the cylinder. In an embodiment, the storage container comprises a cylinder with reversibly attached end caps. In an embodiment, the storage container may include at least one reversibly attached strap. In an embodiment, the storage container may include a plurality of lights that illuminate the interior wall of the cylinder. In an embodiment, the light source may be separated from the storage container. In an embodiment, the storage container may include a battery pack or power bank. In an embodiment, the storage container may include at least one wireless speaker. In an embodiment, the storage container may include a digital tracking tag. In an embodiment, one or more end caps may convert into a table top or into a stool. In an embodiment, the light source may be voice activated.

### BRIEF DESCRIPTION OF THE FIGURES

FIG. 1 is a perspective view of an embodiment of the storage container of the present invention that includes a plurality of lights and a plurality of straps;

FIG. 2 is a cross-sectional view of the outer cylinder and bottom end cap of the storage container of FIG. 1;

FIG. 3 is a cross-sectional view of the storage container of FIG. 1 showing the outer cylinder, the inner cylinder, top end cap, and bottom end cap; and,

FIG. 4 a cross-sectional view of the storage container of FIG. 3 further showing the attachment points for straps or carabiners, an internal hook, and an LED power internal outlet hole.

### DETAILED DESCRIPTION OF THE PRESENT DEVELOPMENT

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

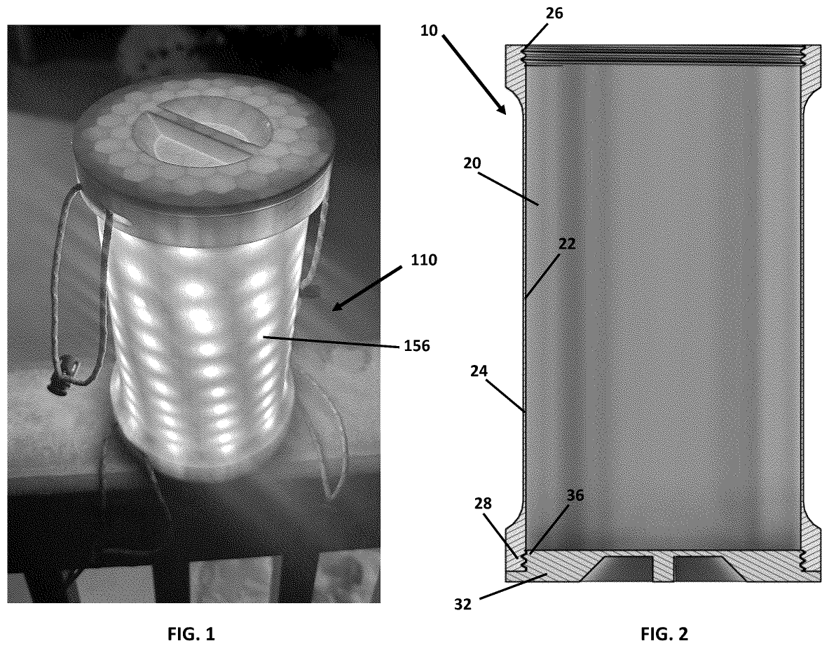

The present development is a storage container as shown in FIGS. 1-4 . The storage container 10 comprises a hollow cylindrical body 20 that defines an interior face 22 and an exterior face 24, a first or top reversibly attached end cap 30, and a second or bottom reversibly attached end cap 32. The end caps 30, 32 may be reversibly attached by any means that can secure the end caps 30, 32 to the cylindrical body 20. An exemplary embodiment is shown in FIG. 2, wherein the interior face 22 includes grooves 26, 28 that complement ridges 34, 36 on the first and second end caps 30, 32, respectively. Optionally, a gasket or seal (not shown) may be positioned between the end caps 30, 32 and the cylindrical body 20 to create a water-resistant seal. Optionally, the exterior wall of the cylindrical body 20 may include at least one mounting point that can allow for a strap, rope, or carabiner 40 to be reversibly attached. Optionally, the top end cap 30, the bottom end cap 32, or both end caps, may include at least one mounting point 42 that can allow for a strap, rope, or carabiner to be reversibly attached, as shown in FIG. 1. The components of the storage container of the present invention may be made from any rigid materials that can be formed into a hollow cylinder 20 or an end cap 30, 32.

The end caps 30, 32 comprise a grid of hexagonal shapes, resembling a honeycomb. The hexagonal grid allows the end cap to deform slightly when exposed to a stressor. The deformation creates a cushioning effect that reduces the risk of fractures to the end cap or to the storage container if the container is dropped or hit. In one embodiment, the hexagonal grid is formed from the peripheries of a plurality of hexagon shapes with hollow centers, as shown in FIG. 5A. In one embodiment, the hexagonal grid is formed from the peripheries of a plurality of hexagon shapes with hollow centers with filled hexagon shapes interspersed within the grid, as shown in FIG. 5B. The filled hexagon shapes may be randomly dispersed or may be dispersed in a predetermined pattern.

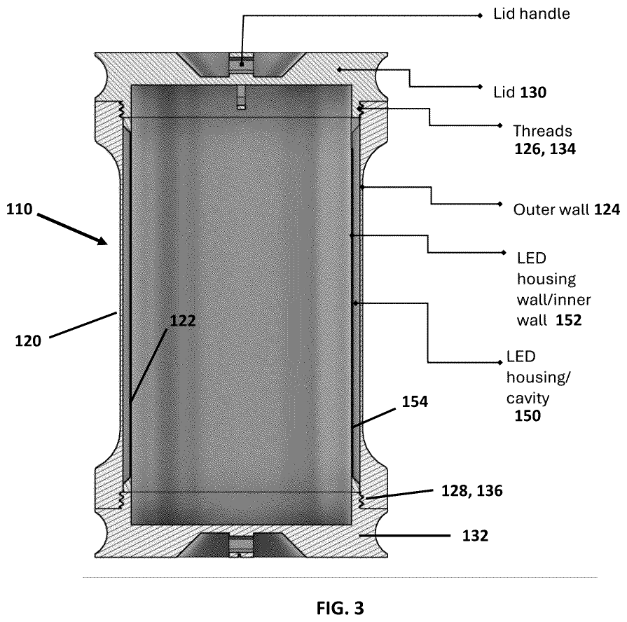

As shown in FIGS. 1 and 3, a second embodiment of the storage container 110 comprises a first hollow cylindrical body 120 that defines an interior face 122 and an exterior face 124, a first or top reversibly attached end cap 130, a second or bottom reversibly attached end cap 132, and a second hollow cylindrical body 150 that defines an interior face 152 and an exterior face 154. The end caps 130, 132 may be reversibly attached by any means that can secure the end caps 130, 132 to the cylindrical body 120. An exemplary embodiment is shown in FIG. 3, wherein the interior face 122 includes grooves 126, 128 that complement ridges 134, 136 on the first and second end caps 130, 132, respectively. The second cylindrical body 150 comprises one or more lighting elements 156, such as light emitting diodes (LED). The lighting elements 156 may be incorporated within the walls of the second cylindrical body 150 or may be fixedly attached to the exterior face 154 of the second cylindrical body 150. For example, the lighting element may be LED strip lights glued to the exterior face of the second cylindrical body 150. The second cylindrical body 150 is proportioned to fit within the first cylindrical body 120. In an exemplary embodiment, the second cylindrical body 150 fits snuggly within the first cylindrical body 120 so a very small gap remains between the second cylindrical body 150 and the first cylindrical body 120. If a lighting element 156 is present, the gap should be large enough to permit the lighting element 156 to fit between the second cylindrical body 150 and the first cylindrical body 120. The second cylindrical body 150 may be fixedly attached to the second cylindrical body 150, or the second cylindrical body 150 may include means to reversibly secure the second cylindrical body 150 to the first cylindrical body 120, such as screw threads or clips (not shown). The advantage of reversibly attaching the second cylindrical body 150 to the first cylindrical body 120 is that the second cylindrical body 150 may be removed and replaced as necessary, such as if the lighting element 156 fails to function.

In an exemplary embodiment, the first cylindrical body 120 is made from a translucent rigid material that can be formed into a hollow cylinder so that illumination from the lighting element 156 is visible through the first cylindrical body 120. The second cylindrical body 150 may be made from any rigid material that can be formed into a hollow cylinder. If an exemplary embodiment, the second cylindrical body 150 is made from a translucent rigid material that can be formed into a hollow cylinder so that illumination from the lighting element 156 is visible through the second cylindrical body 150 thereby lighting the interior of the storage container. Although not required to function as intended, it is recommended that the storage container of the present invention be sufficiently light weight to allow the storage container to float if placed in water.

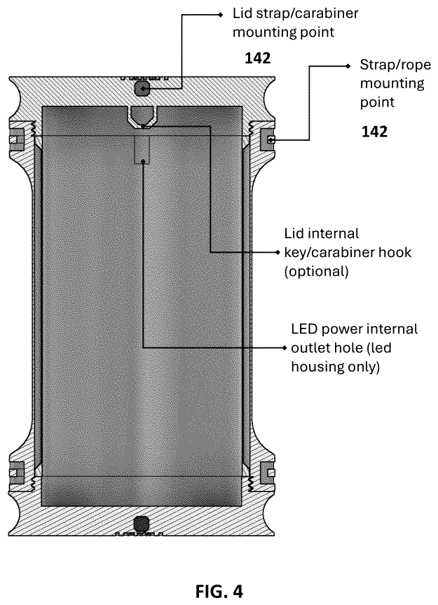

The end caps 130, 132 may be essentially solid pieces, hollow pieces, or semi-hollow pieces. Optionally, a gasket or seal (not shown) may be positioned between the end caps 130, 132 and the cylindrical body 120 to create a water-resistant seal. Optionally, the exterior wall of the cylindrical body 120 may include at least one mounting point 142 that can allow for a strap, rope, or carabiner (not shown) to be reversibly attached. Optionally, the top end cap 130, the bottom end cap 132, or both end caps, may include at least one mounting point 142 that can allow for a strap, rope, or carabiner to be reversibly attached, as shown in FIG. 4.

Optionally, accessories may be attached to or fitted within cavities in the end caps 130, 132. For example, a battery pack, power bank, wireless speaker, digital tracking tag, or a combination thereof, may be included within one or both end caps 130, 132.

The storage container as described herein allows a user to store loose items securely. The lighting element also allows the storage container to function as a lantern, as shown in FIG. 1. The size of the storage container may vary from relatively small, such as to hold car fobs, loose change, or credit card holders, to relatively large, such as to hold paracord, tent stakes, water bottles. Thus, the storage container of the present invention makes carrying loose items easier for the user and reduces the risk of loss of individual items.

It is anticipated that the storage container of the present development may be used for a number of different purposes. For example, and without intending to limit the scope of potential uses, the storage container may be used by an individual who is camping, such as to carry tent stakes and similar small items. The storage container may also be used by tradespeople, such as to carry small plumbing supplies or electrical supplies. The storage container may be used by an individual who is gardening to carry tools for working in flower beds or gardens.

Unless defined otherwise, all technical and scientific terms used herein have the same meaning as commonly understood by one of ordinary skill in the art to which the presently disclosed subject matter pertains. All patents, patent applications, published applications and publications, databases, websites and other published materials referred to throughout the entire disclosure herein, unless noted otherwise, are incorporated by reference in their entirety. Representative methods, devices, and materials are described herein, but are not intended to be limiting unless so noted.

The terms “a”, “an”, and “the” refer to “one or more” when used in the subject specification, including the claims. Thus, for example, reference to “a strap” includes a plurality of such straps, and so forth.

Unless otherwise indicated, all numbers expressing quantities of components, conditions, and otherwise used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

It is understood that, in light of a reading of the foregoing description, those with ordinary skill in the art will be able to make changes and modifications to the present invention without departing from the spirit or scope of the invention, as defined herein. For example, those skilled in the art may substitute materials supplied by different manufacturers than specified herein without altering the scope of the present invention.

What is claimed is:

1. A storage container comprising a first cylindrical body, a top end cap reversibly attached to a first end of the cylindrical body, and a bottom end cap reversibly attached to a second end of the cylindrical body, and a second cylindrical body proportioned to fit within the first cylindrical body, wherein the second cylindrical body includes a plurality of lights that are visible through the first cylindrical body when the second cylindrical body is inserted into the first cylindrical body.

2. The storage container of claim 1 wherein the top end cap or the bottom end cap or both end caps, comprise a hexagonal grid.

3. The storage container of claim 2 wherein the hexagonal grid comprises hollow hexagons.

4. The storage container of claim 2 wherein the hexagonal grid comprises a combination of hollow hexagons and filled hexagons.

5. The storage container of claim 4 wherein the filled hexagons are randomly dispersed.

6. The storage container of claim 4 wherein the filled hexagons are dispersed in a predetermined pattern.

7. The storage container of claim 1 further including at least one strap mounting point.

8. The storge container of claim 1 wherein the top end cap comprises a battery pack, power bank, wireless speaker, digital tracking tag, or a combination thereof.

9. The storge container of claim 1 wherein the bottom end cap comprises a battery pack, power bank, wireless speaker, digital tracking tag, or a combination thereof.
